(19) United States
(12) Patent Application Publication
(10) Pub. No.: US 2018/0203381 A1
(43) Pub. Date: Jul. 19, 2018

(54) TONER CARTRIDGE REPLACEMENT SEAL

(71) Applicant: FLO-TECH, LLC, Middletown, CT (US)

(72) Inventor: Peter Vincent Massaro, Jr., West Haven, CT (US)

(73) Assignee: FLO-TECH, LLC, Middletown, CT (US)

(21) Appl. No.: 15/406,924

(22) Filed: Jan. 16, 2017

(51) Int. Cl. G03G 15/08

(52) U.S. Cl. CPC G03G 15/0881; G03G 15/0891

(57) ABSTRACT

A replacement cartridge toner hopper seal assembly comprising an auger mounted in the hopper, the auger is configured to rotate upon actuation. A toner paddle is coupled to the auger. An original hopper seal has an original hopper seal first end opposite an original hopper seal second end, the original hopper seal is coupled to the auger proximate the original hopper seal first end and proximate the toner paddle. A replacement seal extension is coupled to the original hopper seal second end. A window seat is coupled to a cartridge upper toner window of the cartridge toner hopper. The replacement seal extension is coupled to the window seat. The replacement seal extension being removable from the window seat responsive to actuation of the auger.

### BACKGROUND

The present disclosure is directed to an image forming apparatus such as a copying machine, a printer or a facsimile machine, and relates to a cartridge for use with the image forming apparatus.

Printer cartridges are filled with toner. The toner is sealed inside the printer cartridge to prevent toner leakage during transportation of the printer cartridge. The seal is removed prior to installation of the printer cartridge for use in the image forming apparatus.

The seal has been improved to include a mechanism in the printer cartridge that can unseal the printer cartridge automatically without manual removal of the seal.

As a result, it is possible to prevent toner leakage which can be caused by vibration or impact during transportation of the cartridge. Further, there is no need for a user to unseal the toner seal member, and therefore usability is improved.

After a printer cartridge has expended the toner preloaded in the cartridge, the cartridge is either discarded or refurbished for reuse. The refurbished cartridge requires a refill of toner that necessitates a resealing the cartridge. Replacement of the original toner seal requires the cartridge to be opened adding cost to the refurbishment of the cartridge.

A new replacement seal is needed that eliminates the need to crack open the cartridge for refurbishment and replacement of the toner seal.

### SUMMARY

In accordance with the present disclosure, there is provided a replacement cartridge toner hopper seal assembly comprising an auger mounted in the hopper, the auger is configured to rotate upon actuation. A toner paddle is coupled to the auger. An original hopper seal has an original hopper seal first end opposite an original hopper seal second end, the original hopper seal is coupled to the auger proximate the original hopper seal first end and proximate the toner paddle. A replacement seal extension is coupled to the original hopper seal second end. A window seat is coupled to a cartridge upper toner window of the cartridge toner hopper. The replacement seal extension is coupled to the window seat. The replacement seal extension being removable from the window seat responsive to actuation of the auger.

In another and alternative embodiment, the replacement cartridge toner hopper seal assembly further comprises a double sided adhesive coupled between the original hopper seal second end and the replacement seal extension.

In another and alternative embodiment, the replacement cartridge toner hopper seal assembly further comprises an adhesive area formed on the replacement seal extension proximate the window seat.

In another and alternative embodiment, the adhesive area is configured to adhere to a seal contact area of the window seat and configured to be releasable responsive to the auger actuation.

In another and alternative embodiment, the replacement cartridge toner hopper seal assembly further comprises a window seat adhesive coupled between the window seat and an exterior surface of the cartridge upper toner window; wherein the window seat adhesive is configured to attach and seal the window seat against the exterior surface of the cartridge upper toner window.

In another and alternative embodiment, the original hopper seal has a dimension reduced in order to accommodate attachment of the replacement seal extension.

In another and alternative embodiment, the original hopper seal dimension reduction is performed without breaking the hopper apart or removal of the original hopper seal from the auger.

In accordance with the present disclosure, there is provided a replacement cartridge toner hopper seal assembly comprising an auger mounted in the hopper, the auger configured to rotate upon actuation; an original hopper seal having an original hopper seal first end opposite an original hopper seal second end, the original hopper seal coupled to the auger proximate the original hopper seal first end and proximate the toner paddle; the original hopper seal having an original length dimension, wherein a portion of the original length is removed from the original hopper seal to form the second end; a replacement seal extension coupled to the original hopper seal second end by a double sided adhesive; and a window seat coupled to a cartridge upper toner window of the cartridge toner hopper by a window seat adhesive, the replacement seal extension coupled to the window seat proximate an adhesive area of the replacement seal extension, the replacement seal extension being removable from the window seat responsive to actuation of the auger

In another and alternative embodiment, the window seat comprises a seal contact surface configured to receive the replacement seal extension.

In another and alternative embodiment, the window seat comprises an outer frame and a flange portion extending orthogonally from the outer frame, wherein the flange portion comprises an angled profile.

In another and alternative embodiment, the angled profile comprises the flange portion having a taller portion opposite a shorter portion configured to gradually slope in a decreasing height from the taller portion toward the shorter portion.

In another and alternative embodiment, the adhesive area of the replacement seal extension comprises a release adhesive.

In another and alternative embodiment, the adhesive area of the replacement seal extension is located opposite the double sided adhesive.

In accordance with the present disclosure, there is provided a process for replacing a cartridge toner hopper seal, the process comprises cutting a portion from a second end of an original hopper seal having an original hopper seal first end opposite the original hopper seal second end, the original hopper seal coupled to an auger of a cartridge toner hopper proximate the original hopper seal first end; The process includes attaching a replacement seal extension to the original hopper seal second end; and sealing the cartridge toner hopper with the replacement seal extension.

In another and alternative embodiment, the cutting step includes extending the second end of the original hopper seal out of a cartridge upper toner window.

In another and alternative embodiment, the attaching step comprises attaching a double sided adhesive to the original hopper seal second end and the replacement seal extension.

In another and alternative embodiment, the sealing step comprises attaching an adhesive area of the replacement seal extension to a window seat, the adhesive area being located opposite the second end of the original hopper seal.

In another and alternative embodiment, the process further comprises attaching the window seat to a cartridge upper toner window with window seat adhesive; wherein the window seat comprises a window seat opening formed within an outer frame of the window seat, the window seat opening configured to allow toner to flow into and out of the cartridge toner hopper.

In another and alternative embodiment, the process further comprises unsealing the replacement seal extension from the window seat responsive to actuation of the auger.

In another and alternative embodiment, the process further comprises reusing the replacement seal extension, wherein the step of attaching the replacement seal extension to the original hopper seal second end is attached by use of at least one of a releasable liner and a hot melt wax base adhesive.

Other details of the replacement cartridge toner hopper seal assembly are set forth in the following detailed description and the accompanying drawing wherein like reference numerals depict like elements.

### BRIEF DESCRIPTION OF THE DRAWINGS

FIG. 1 is a perspective view for illustrating mounting and demounting of the cartridge with respect to an image forming apparatus main assembly in an exemplary embodiment;

FIG. 2 is a perspective view of an exemplary cartridge assembly;

FIG. 3 is a perspective view of an exemplary cartridge assembly;

FIG. 4 is a perspective view of an exemplary cartridge assembly;

FIG. 5 is a perspective view of an exemplary cartridge assembly;

FIG. 6 is a cross-sectional side view of an exemplary hopper with seal assembly;

FIG. 7 is an exploded side perspective view of an exemplary hopper with seal assembly;

FIG. 8 is a perspective view of an exemplary hopper seal assembly;

FIG. 9 is a perspective view of a portion of an exemplary seal assembly;

FIG. 10 is a perspective view of a portion of an exemplary seal assembly;

FIG. 11 is a perspective view of an exemplary window seat;

FIG. 12 is a perspective view of an exemplary window seat adhesive;

FIG. 13 is an exploded view of an exemplary seal assembly;

FIG. 14 is a perspective view of an exemplary seal assembly.

### DETAILED DESCRIPTION

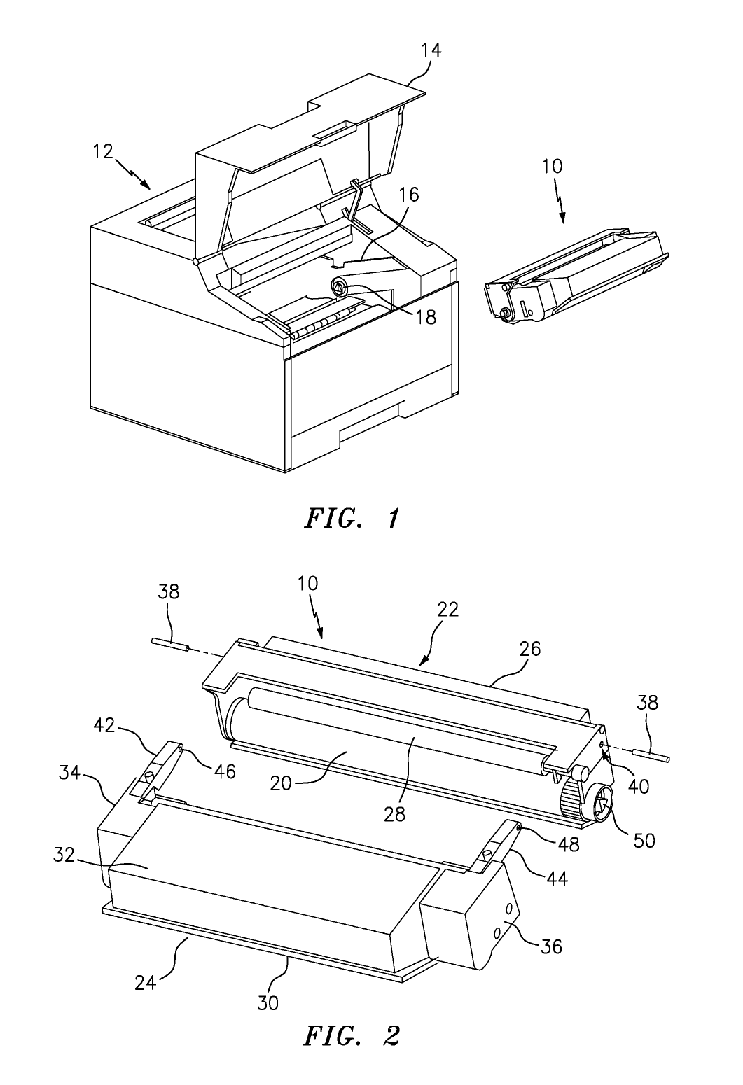

Referring now to FIGS. 1 and 2, illustrating a perspective view of a cartridge 10 and an image forming apparatus main assembly 12. A door 14 is configured for mounting and demounting the cartridge 10. As shown in FIG. 1, the apparatus main assembly 12 includes the door 14. In a state in which the door 14 is opened, the cartridge 10 can be mounted into and demounted from the image forming apparatus main assembly 12 along a guide rail 16.

When the cartridge 10 is mounted, a driving shaft 18 to be driven by a motor (not shown) of the apparatus main assembly 12 engaged with a drum drive 50 provided on the cartridge 10. As a result, the photosensitive drum 20 connected with the drum drive 50 is rotated by receiving a driving force from the apparatus main assembly 12.

FIG. 2 is a perspective view of the cartridge 10. As shown in FIG. 2, the cartridge 10 includes a wastebin 22 and a hopper 24. The wastebin 22 includes a wastebin frame 26, the photosensitive drum 20, and the charging roller 28. The hopper 24 includes a cap 30, a toner frame 32, first hopper side member 34 and second hopper side member 36.

The cartridge 10 connects the wastebin 22 and the hopper 24 rotationally movably with each other by a cartridge connector 38. Specifically, at each of the longitudinal end portions of the wastebin frame 26, an engaging hole 40 is configured to receive the cartridge connector 38. The cartridge connectors 38 engage the hopper 24 at ends of arm portions 42 and 44 formed on the first and second hopper side members 34 and 36, respectively, located at the longitudinal end portions of the hopper 24, via rotational movement holes 46 and 48. The arm portions 42 and 44 are aligned with predetermined positions of the wastebin 22. The cartridge connectors 38 are inserted into the rotational movement holes 46 and 48 and the engaging holes 40, so that the wastebin 22 and the hopper 24 are connected with each other rotatably about the cartridge connectors 38.

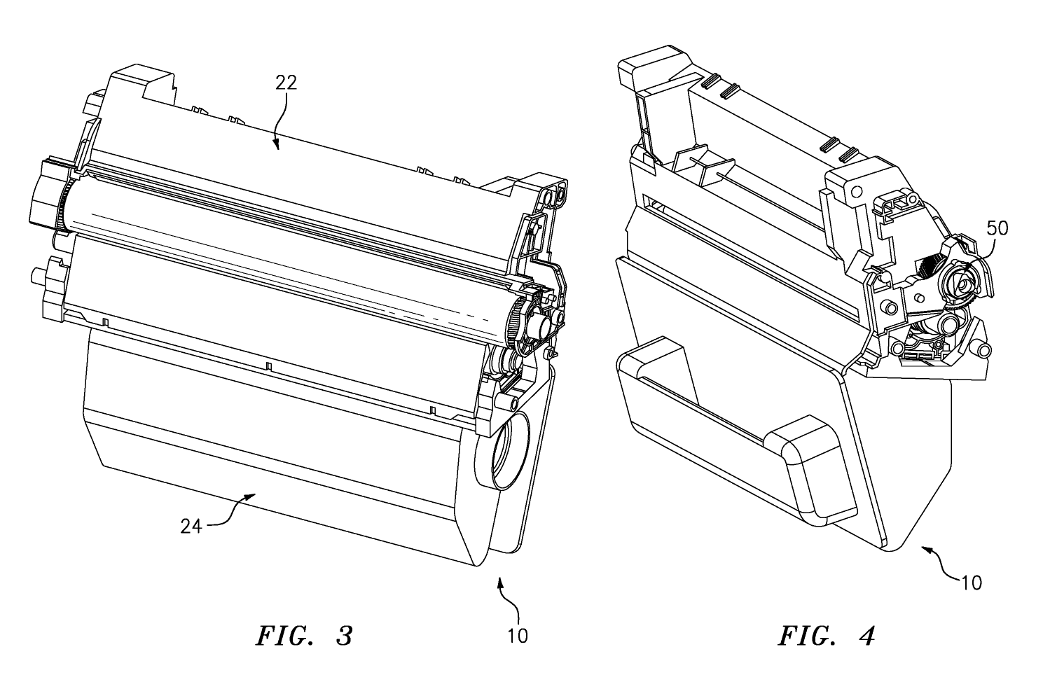

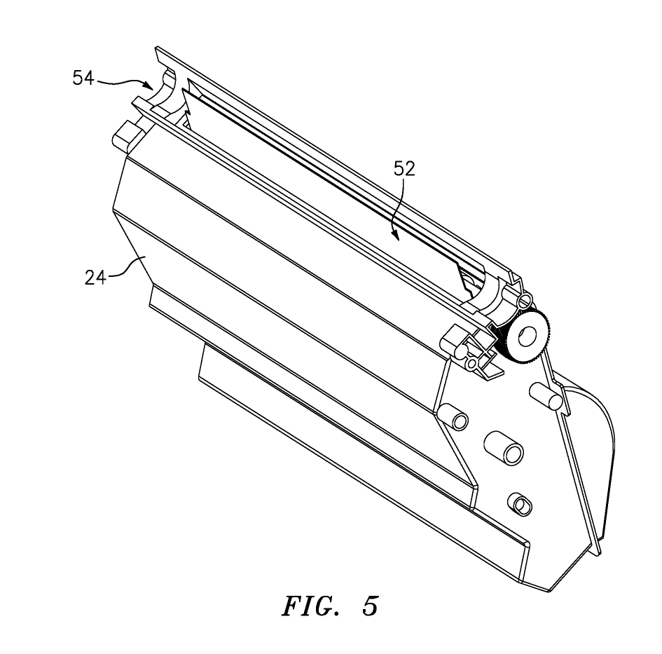

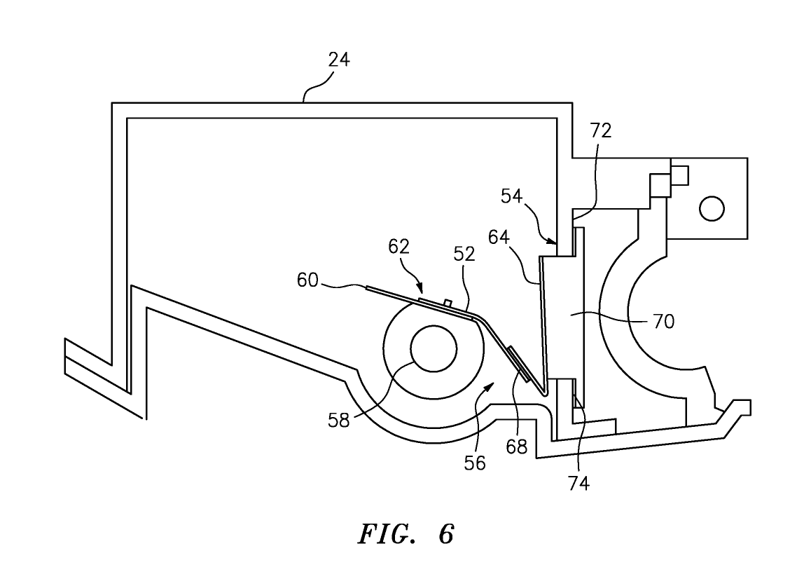

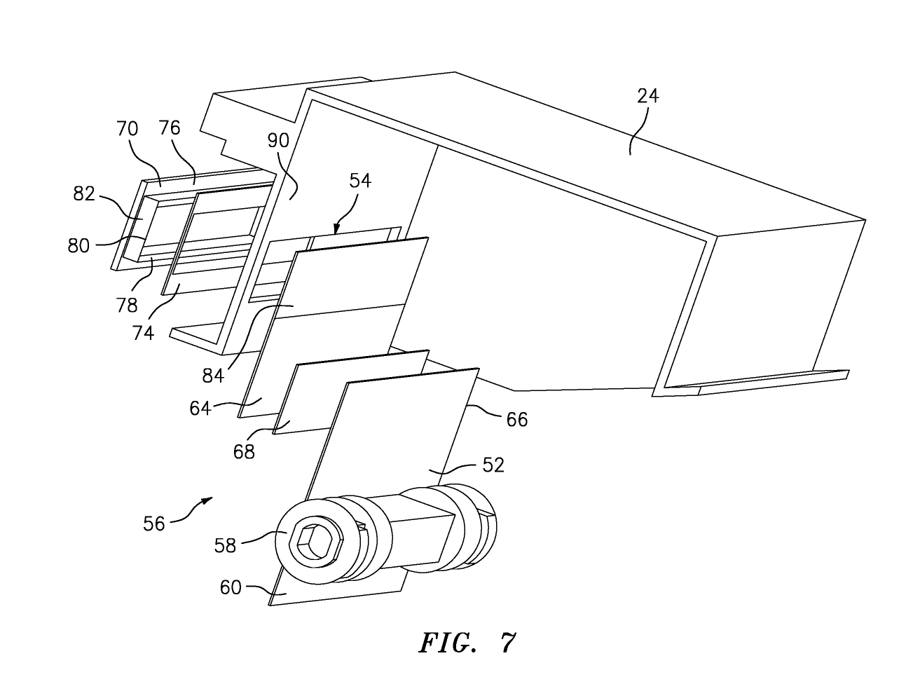

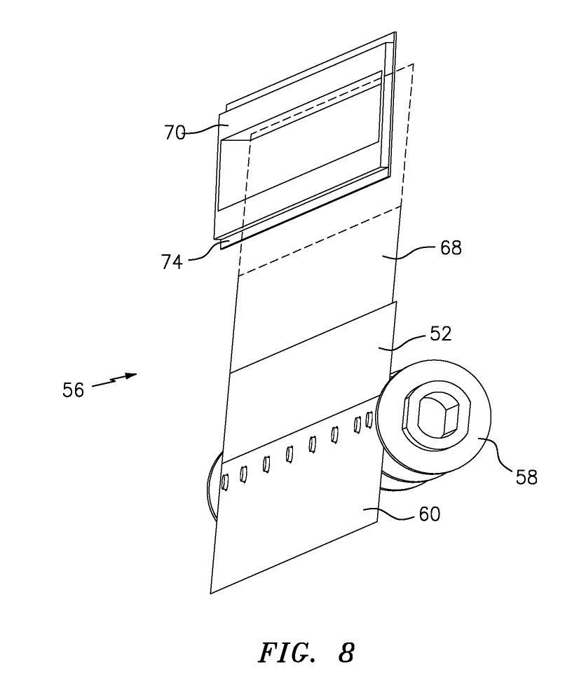

Another exemplary embodiment of an assembled cartridge 10 is shown at FIGS. 3-5 from different perspective views. The wastebin 22 and hopper 24 are assembled into a single unitary cartridge 10. FIG. 5 shows a portion of an original hopper seal 52. The original hopper seal 52 is shown extending out of a cartridge upper toner window 54. The original hopper seal 52 has been cut to reduce the length of the original hopper seal 52. The original hopper seal 52 length is reduced to accommodate an improved new replacement hopper seal assembly 56 shown in FIGS. 6 through 8.

In an exemplary embodiment, replacement hopper seal assembly 56 includes a combination of the original hopper seal 52 coupled to an auger 58 coupled to a toner paddle 60. The toner paddle is also coupled to the auger 58 adjacent a first end 62 of the original hopper seal 52. A replacement seal extension or simply seal extension 64 is coupled to the original hopper seal 52 at an original hopper seal second end 66. The original hopper seal second end 66 is the portion of the original hopper seal 52 that is cut down, reduced in length. A double sided adhesive 68 can be employed to couple the seal extension 64 to the original hopper seal 52.

A window seat 70 is inserted into the cartridge upper toner window 54. The window seat 70 is fixed to the cartridge upper toner window 54 on the exterior surface 72 of the cartridge upper toner window 54. A window seat adhesive 74 is employed to adhere the window seat 70 to the exterior surface 72 of the cartridge upper toner window 54. In an exemplary embodiment, the window seat adhesive 74 is configured as a rectilinear pre-cut sheet that matches surfaces of an outer frame 76 of the window seat 70 that abuts the exterior surface 72 of the cartridge upper toner window 54.

The replacement seal extension 64 is coupled to the window seat 70 proximate the cartridge upper toner window 54. The window seat 70 includes a seal contact surface 78 formed at a perimeter 80 of a flange portion of the window seat 70. The replacement seal extension 64 can include an adhesive area 84 in a region distal from and opposite the double sided adhesive 68. The adhesive area 84 of the replacement seal extension 64 is configured to attach to the window seat 70 seal contact surface 78 and be releasable upon auger 58 actuation, thus unsealing the cartridge 10 allowing toner release. In an exemplary embodiment, the replacement seal extension is attached to the original hopper seal second end by use of at least one of a releasable liner or a hot melt wax base adhesive. The adhesive area 84 can comprise a release adhesive such as a hot wax adhesive material. The hot wax based adhesive can be applied and attached by low heat application.

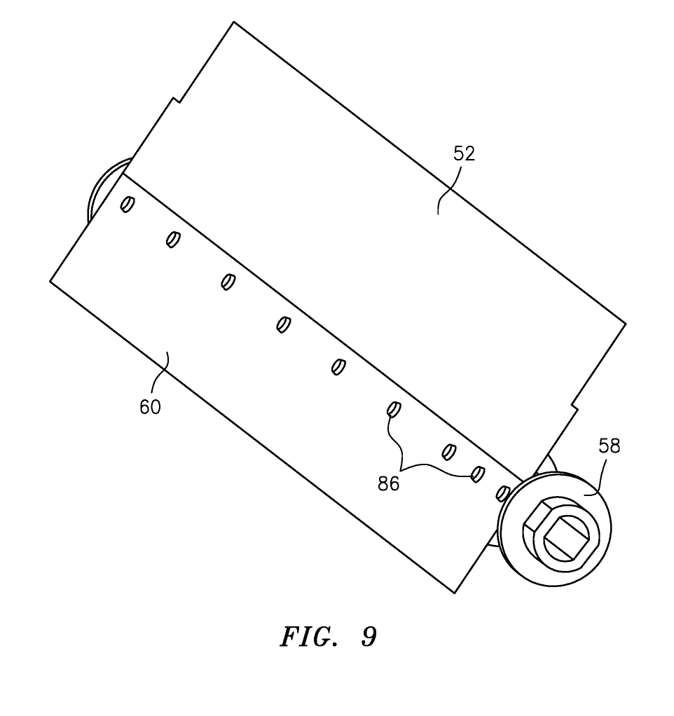

FIGS. 9 through 14 show more details of the individual components of the new hopper seal assembly 56. At FIG. 9, the auger 58 can include surface features 86, such as lugs, pegs, and the like that penetrate preset holes 88 formed in the toner paddle 60 and original hopper seal 52. The surface features 56 improve contact and adhesion of the toner paddle 60 and original hopper seal 52 to the auger 58. The original hopper seal 52 is shown cut-down, reduced in size, from its original length in order to accommodate the addition of the replacement seal extension 64.

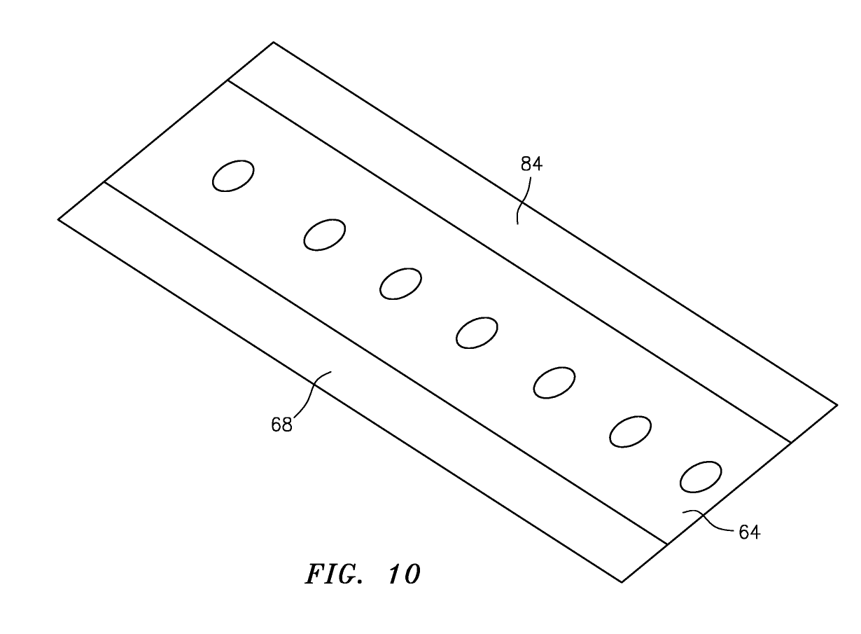

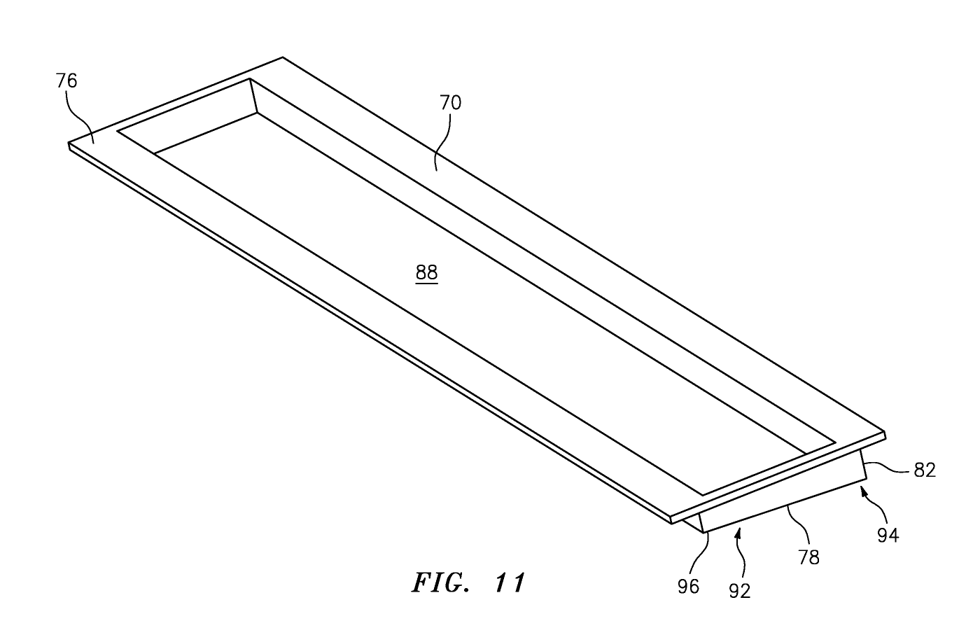

FIG. 10 illustrates an exemplary replacement seal extension 64 with the adhesive area 84 opposite the location with the double sided adhesive 68. As can be seen, the exemplary replacement seal extension 64 can be a rectangular sheet with a width similar to the original hopper seal 52. The adhesive area 84 can be sized to cover a window seat opening 88.

The window seat 70, shown in FIG. 11, is generally rectilinear and sized to insert and fit into the cartridge upper toner window 54 snugly, so as to form a tight seal from toner leakage. The cartridge upper toner window 54 is reduced in size negligibly with respect to toner outflow. The outer frame 76 and window seat adhesive 74 forms the remainder of the toner sealing function. The flange portion 82 extends orthogonally away from the plane of the outer frame 76, such that the flange portion 82 can extend into the cartridge upper toner window 54 past an inner surface 90 of the cartridge upper toner window 54. The flange portion 82 of the window seat 70 includes an angled profile 92. The flange portion 82 does not extend equidistant orthogonally away from the plane of the outer frame 76. Thus, the angled profile 92 is formed, as can be seen in FIG. 11. A taller portion 94 gradually slopes in a decreasing height toward a shorter portion 96 opposite thereto, to form the angled profile 92. The angled profile 92 improves the capacity of the replacement seal extension 64 to release from the seal contact surface 78 upon actuation of the auger 58. The angled profile 92 allows for the optimum release of the replacement seal extension 64 as the auger 58 rotates and pulls the replacement seal extension 64 away from the seal contact surface 78.

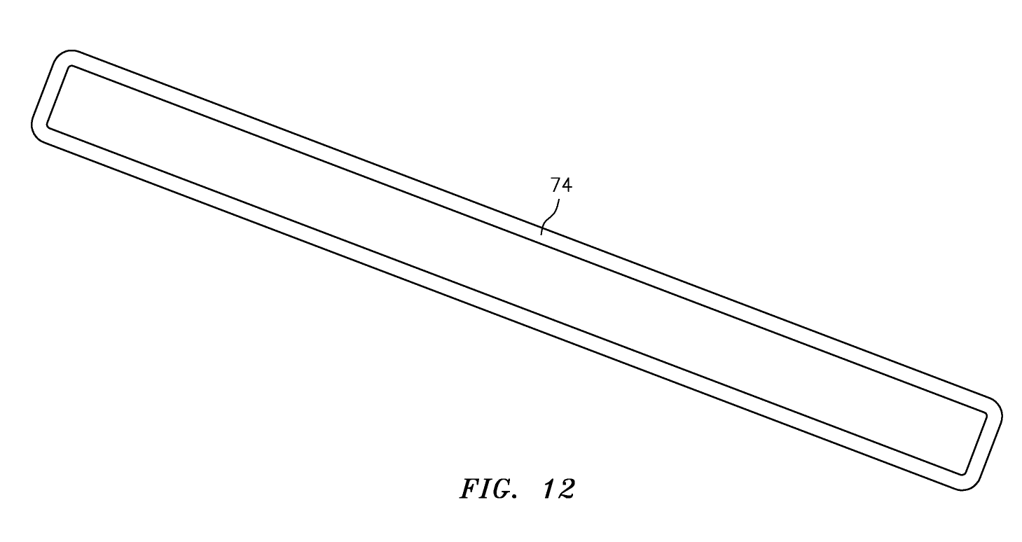

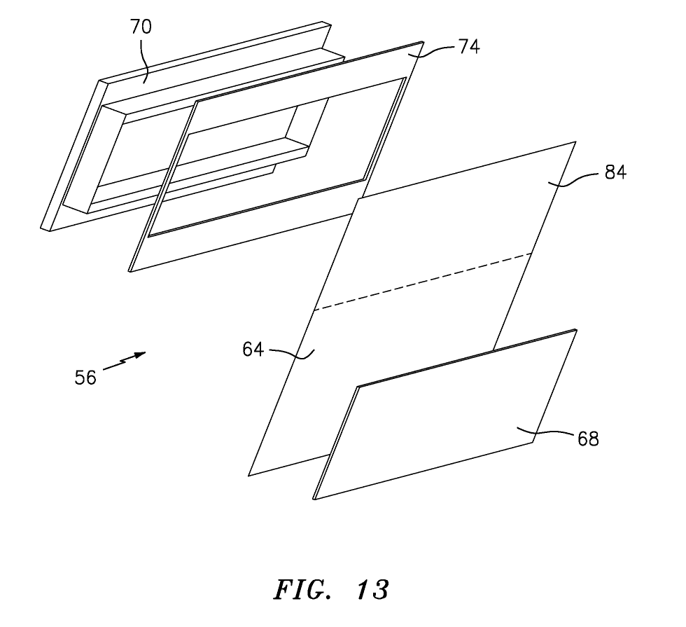

The window seat adhesive 74 is shown at FIG. 12. The window seat adhesive 74 is generally rectilinear in shape and configured to snugly fit over the outer frame 76 and abut the exterior surface 72 of the cartridge upper toner window 54. The window seat adhesive employs a pressure sensitive adhesive.

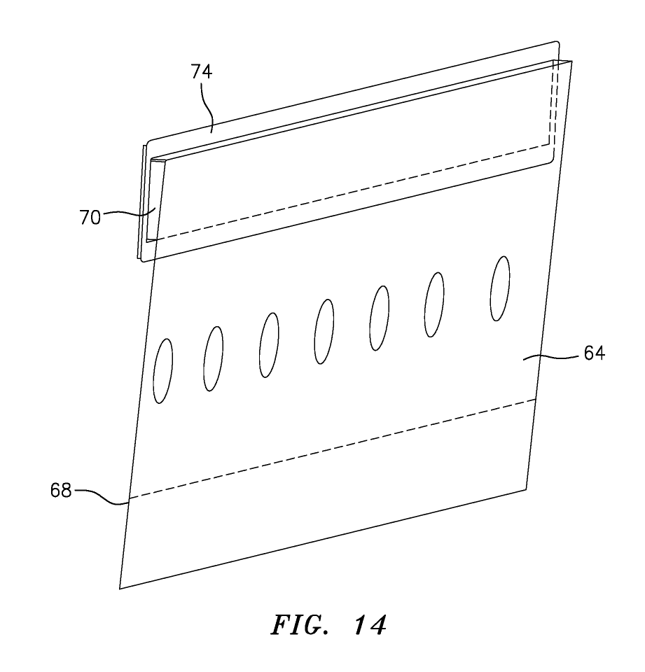

FIGS. 13 and 14 illustrate an exploded view and assembled view of the exemplary replacement hopper seal assembly 56. The replacement seal extension 64 is shown with the double sided adhesive 68 attachable to the replacement seal extension 64 in a location distal from the adhesive area 84 were the hot wax adhesive can be applied to contact and adhere with the window seat 70 seal contact surface 78. The window seat adhesive 74 is shown interposed between the replacement seal extension 64 and the window seat 70.

The replacement hopper seal assembly 56 can be assembled without having to break open the hopper 24. The original hopper seal 52 can be extended out of the cartridge upper toner window 54. The original hopper seal 52 does not have to be removed from the auger 58 or toner paddle 60. The original hopper seal 52 can be cut down to size such that the replacement seal extension 64 can be attached to the original hopper seal 52 via the double sided adhesive 68 and extend to seal the cartridge upper toner window 54 opening. The window seat 70 can be inserted into the cartridge upper toner window 54 snuggly against the window seat adhesive 74 to seal the cartridge upper toner window 54 from toner leakage. A releasable hot melt wax base adhesive can adhere the replacement seal extension 64 to the seal contact surface 78 of the window seat 70, thus sealing the toner in the hopper 24.

During subsequent transportation of the replenished cartridge 10, the toner is sealed inside the hopper 24. Upon installation of the cartridge 10 into the image forming apparatus 12 and subsequent actuation of the drum drive 50 and auger 58 the replacement seal extension 64 of the hopper seal assembly 56 can detach from the seal contact surface 78 and allow toner to flow out of the hopper 24. The auger 58 and toner paddle 60 can maintain their original function without being impacted by the seal replacement.

There has been provided a toner cartridge replacement seal. While the toner cartridge replacement seal has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. A replacement cartridge toner hopper seal assembly comprising:
a wastebin including a photosensitive drum and charging roller within, said wastebin attached to the cartridge toner hopper;
an auger mounted in said cartridge toner hopper, said auger configured to rotate upon actuation;
a toner paddle coupled to said auger;
an original hopper seal having an original hopper seal first end opposite an original hopper seal second end, said original hopper seal coupled to said auger proximate said original hopper seal first end and proximate said toner paddle;
a replacement seal extension coupled to said original hopper seal second end; and
a window seat coupled to a cartridge upper toner window of the cartridge toner hopper, said replacement seal extension coupled to said window seat, said replacement seal extension being removable from said window seat responsive to actuation of said auger.

2. The replacement cartridge toner hopper seal assembly according to claim 1, further comprising:
a double sided adhesive coupled between said original hopper seal second end and said replacement seal extension.

3. The replacement cartridge toner hopper seal assembly according to claim 1, further comprising:
an adhesive area formed on said replacement seal extension proximate said window seat.

4. The replacement cartridge toner hopper according to claim 3, wherein said adhesive area is configured to adhere to a seal contact area of said window seat and configured to be releasable responsive to the auger actuation.

5. The replacement cartridge toner hopper seal assembly according to claim 1, further comprising a window seat adhesive coupled between said window seat and an exterior surface of said cartridge upper toner window; wherein said window seat adhesive is configured to attach and seal said window seat against said exterior surface of said cartridge upper toner window.

6. The replacement cartridge toner hopper seal assembly according to claim 1, wherein said original hopper seal has a dimension reduced in order to accommodate attachment of said replacement seal extension.

7. The replacement cartridge toner hopper seal assembly according to claim 6, wherein said original hopper seal dimension reduction is performed without breaking said cartridge toner hopper apart or removal of said original hopper seal from said auger.

8. A replacement cartridge toner hopper seal assembly comprising:
a wastebin including a photosensitive drum and charging roller within, said wastebin attached to the cartridge toner hopper;
an auger mounted in said cartridge toner hopper, said auger configured to rotate upon actuation;
an original hopper seal having an original hopper seal first end opposite an original hopper seal second end, said original hopper seal coupled to said auger proximate said original hopper seal first end and proximate a toner paddle; said original hopper seal having an original length dimension, wherein a portion of said original length is removed from said original hopper seal to form said second end;
a replacement seal extension coupled to said original hopper seal second end by a double sided adhesive; and
a window seat coupled to a cartridge upper toner window of the cartridge toner hopper by a window seat adhesive, said replacement seal extension coupled to said window seat proximate an adhesive area of said replacement seal extension, said replacement seal extension being removable from said window seat responsive to actuation of said auger.

9. The replacement cartridge toner hopper seal assembly according to claim 8, wherein said window seat comprises a seal contact surface configured to receive said replacement seal extension.

10. The replacement cartridge toner hopper seal assembly according to claim 9, wherein said window seat comprises an outer frame and a flange portion extending orthogonally from said outer frame, wherein said flange portion comprises an angled profile.

11. The replacement cartridge toner hopper seal assembly according to claim 9, wherein said angled profile comprises said flange portion having a taller portion opposite a shorter portion configured to gradually slope in a decreasing height from the taller portion toward the shorter portion.

12. The replacement cartridge toner hopper seal assembly according to claim 8, wherein said adhesive area of said replacement seal extension comprises a release adhesive.

13. The replacement cartridge toner hopper seal assembly according to claim 8, wherein said adhesive area of said replacement seal extension is located opposite said double sided adhesive.

14. A process for replacing a cartridge toner hopper seal, said process comprising:
cutting a portion from a second end of an original hopper seal having an original hopper seal first end opposite the original hopper seal second end, said original hopper seal coupled to an auger of a cartridge toner hopper proximate said original hopper seal first end;
attaching a replacement seal extension to said original hopper seal second end; and
sealing said cartridge toner hopper with said replacement seal extension.

15. The process of claim 14, wherein said cutting step includes extending said second end of said original hopper seal out of a cartridge upper toner window.

16. The process of claim 14, wherein said attaching step comprises attaching a double sided adhesive to said original hopper seal second end and said replacement seal extension.

17. The process of claim 14, wherein said sealing step comprises attaching an adhesive area of said replacement seal extension to a window seat, said adhesive area being located opposite said second end of said original hopper seal.

18. The process of claim 17, further comprising:
attaching said window seat to a cartridge upper toner window with window seat adhesive; wherein said window seat comprises a window seat opening formed within an outer frame of said window seat, said window seat opening configured to allow toner to flow into and out of said cartridge toner hopper.

19. The process of claim 14, further comprising:
unsealing said replacement seal extension from said window seat responsive to actuation of said auger.

20. The process of claim 14, further comprising:
reusing said replacement seal extension, wherein said step of attaching said replacement seal extension to said original hopper seal second end is attached by use of at least one of a releasable liner and a hot melt wax base adhesive.
